(19) United States
(12) Patent Application Publication
(10) Pub. No.: US 2017/0308246 A1
(43) Pub. Date: Oct. 26, 2017

(54) OPTIMIZING ATTENTION RECALL OF CONTENT IN INFINITE SCROLL

(71) Applicant: International Business Machines Corporation, Armonk, NY (US)

(72) Inventors: Lisa Seacat DeLuca, Baltimore, MD (US); Jenny S. Li, Danbury, CT (US); Dana L. Price, Surf City, NC (US); Aaron J. Quirk, Cary, NC (US)

(21) Appl. No.: 15/133,357

(22) Filed: Apr. 20, 2016

(51) Int. Cl. G06F 3/0482; G06F 3/0484; G06F 3/0485; G06F 17/30

(52) U.S. Cl. CPC G06F 3/0482; G06F 17/3053; G06F 3/04845; G06F 3/0485

(57) ABSTRACT

In an approach for optimizing content recall in an infinite scroll, a request is received to access an application, wherein the application includes an infinite scroll feature with a content item. A processor monitors user interaction with the content item within the application. A processor compares the user interaction with the content item to historical user consumption data, wherein the historical user consumption data includes average duration of time per user interaction session, geographic location, and type of application. A processor assigns a weight factor to the content item based, in part, on the comparison of the user interaction with the application to the historical user consumption data. A processor adds the content item to a list of previously consumed content items.

### BACKGROUND

The present invention relates generally to the field of infinite scrolling, and more particularly to optimizing content recall in an infinite scroll.

Infinite scroll is a feature in which as a user scrolls through content on a webpage or mobile application, more content is loaded automatically when the user approaches the bottom of the webpage. Infinite scrolling offers an efficient way to browse through a lot of content without having to wait for the next page to load. The infinite scroll feature is used by many social media websites and mobile applications to allow users to endlessly scroll through content including status updates, articles, pictures, tweets, etc.

Typically, websites and mobile applications using infinite scroll organize the content by putting the most recently added content items and/or the most recently interacted with content items at the top. As new content is created or current content is interacted with, the ordering of the content may be updated and reorganized. Depending on the website or mobile application, a user can interact with a content item by commenting on it, sharing it, liking it, reposting it, clicking an associated link, etc.

### SUMMARY

Aspects of an embodiment of the present invention disclose a method, computer program produce, and computer system for optimizing content recall in an infinite scroll. A processor receives a request to access an application, wherein the application includes an infinite scroll feature with a content item. A processor monitors user interaction with the content item within the application. A processor compares the user interaction with the content item to historical user consumption data, wherein the historical user consumption data includes average duration of time per user interaction session, geographic location, and type of application. A processor assigns a weight factor to the content item based, in part, on the comparison of the user interaction with the application to the historical user consumption data. A processor adds the content item to a list of previously consumed content items.

### BRIEF DESCRIPTION OF THE DRAWINGS

FIG. 1 is a functional block diagram illustrating a computing environment, in accordance with an embodiment of the present invention;

FIG. 2 is a flowchart depicting operational steps of a recall program, for monitoring and analyzing a user's interaction with content items in an infinite scroll, on a server computer within the environment of FIG. 1, in accordance with an embodiment of the present invention;

FIG. 3 depicts a block diagram of internal and external components of the computer systems of FIG. 1, in accordance with an embodiment of the present invention.

### DETAILED DESCRIPTION

Embodiments of the present invention recognize the difficulty in finding a content item in an infinite scroll once a user has scrolled past the content item or exited and reopened the application. In some instances, a user will see a content item in an infinite scroll, but will not interact with the content item. Then, the user may later decide he or she wants to interact with the content item but is unable to find it. For example, in instances where a news website uses an infinite scroll to present news articles to users, a user may see an article on a presidential debate but not open it and keep scrolling. Later, after scrolling for a while or closing the website, the user may decide he or she wants to read that article, but does not remember where the article was located in the infinite scroll. Thus, the user will have to try scrolling through the infinite scroll again and may be unable to find the article because of the vast number of articles. Embodiments of the present invention provide solutions for recalling or finding content items in an infinite scroll that a user does not directly interact with or bookmark. In this manner, as discussed in greater detail herein, embodiments of the present invention can provide a way to recall or find content items from an infinite scroll based, at least in part, on a user's historical consumption habits and the user's current interaction.

The present invention will now be described in detail with reference to the Figures.

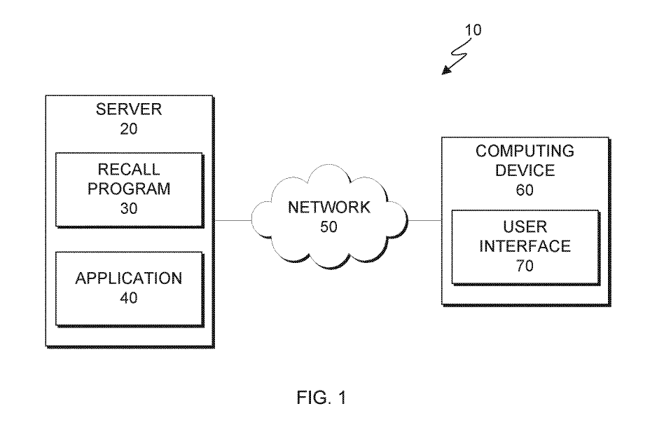

FIG. 1 is a functional block diagram of computing environment 10, in accordance with an embodiment of the present invention. FIG. 1 provides only an illustration of one embodiment and does not imply any limitations with regard to the environments in which different embodiments may be implemented.

In the depicted embodiment, computing environment 10 includes server 20 and computing device 60 interconnected over network 50. Network 50 may be a local area network (LAN), a wide area network (WAN) such as the Internet, the public switched telephone network (PSTN), any combination thereof, or any combination of connections and protocols that will support communications between server 20 and computing device 60, in accordance with embodiments of the invention. Network 50 may include wired, wireless, or fiber optic connections.

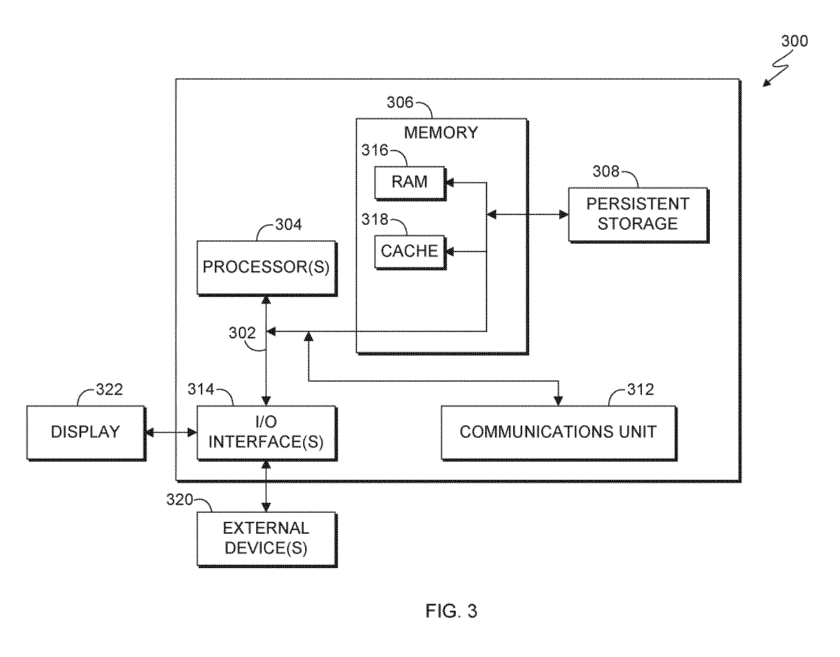

Server 20 and computing device 60 can be desktop computers, laptop computers, tablet computers, smart phone, specialized computer servers, or any programmable electronic device capable of receiving and sending data and communicating with each other via network 50. In certain embodiments, server 20 and computing device 60 represent computer systems utilizing clustered computers and components to act as a single pool of seamless resources when accessed through network 50. For example, such embodiments may be used in data center, cloud computing, storage area network (SAN), and network attached storage (NAS) applications. In certain embodiments, server 20 and computing device 60 represent virtual machines. In general, server 20 and computing device 60 are representative of any electronic devices, or combination of electronic devices, capable of executing machine-readable program instructions, as described in greater detail with regard to FIG. 3. Computing environment 10 may include additional computing devices, servers, computers, mobile devices, or other devices not shown.

Server 20 operates to process requests by a user of a user interface, such as user interface 70 (e.g., via TCP/IP) on a computing device, such as computing device 60. In the depicted embodiment, server 20 includes recall program 30 and application 40.

Recall program 30 operates to monitor a user's interaction with content items in an infinite scroll in a user interface, such as user interface 70, associated with an application, such as application 40. User interaction may include, but is not limited to, the duration of time the user spends in the application, the geographic location where the user runs the application, and the types of content items the user interacts with in the application. In some embodiments, additional indications of user interaction include, but are not limited to, pausing on a content item, sharing the content item, liking the content item, commenting on the content item, saving the content item, or clicking a link associated with it. In this embodiment, recall program 30 stores the user interactions as historical user consumption data. Then, recall program 30 analyzes the data to determine historical user consumption patterns of the content items. Next, recall program 30 assigns a weight for each content item based on the historical user consumption data. In some embodiments, recall program 30 may generate a list of the weighted content items. In some embodiments, recall program 30 resides on server 20 and has access to application 40. In other embodiments, recall program 30 may reside on another server, or another computing device, provided that recall program 30 has access to location identifying information associated with server 20.

Application 40 operates to display content items from one or more sources. In general, application 40 can be implemented by any web application, mobile application, computer program, website, subset of a website, etc. For example, application 40 can be implemented using a browser and web portal or any program that receives input from and displays content items to users through a user interface. In this embodiment, application 40 is associated with user interface 70. For example, if application 40 is a website, then user interface 70 is the web browser that a user uses to access the website. In some embodiments, application 40 resides on server 20. In other embodiments, application 40 may reside on another server, or another computing device, provided that application 40 has access to location identifying information associated with server 20.

Computing device 60 operates to enable a user to run a user interface, such as user interface 70, of an application, such as application 40. In the depicted embodiment, computing device 60 includes user interface 70.

User interface 70 may be a web browser or application software, such as a mobile or tablet application, which is associated with an application, such as application 40. In this embodiment, user interface 70 has an infinite scroll feature for users to view content items. An infinite scroll, as used herein, refers to a feature in which as a user scrolls through content items on a webpage, more content is loaded automatically when the user approaches the bottom of the webpage. Content items may include, but are not limited to, links to articles, status updates, pictures, tweets, and embedded videos. In this embodiment, a user may access user interface 70 of application 40 and scroll through content items in the infinite scroll. For example, a user can open a news application and scroll through news articles presented in an infinite scroll. In some embodiments, a user may interact with a content item by pausing on it, sharing it, liking it, commenting on the content item, saving the content item, or clicking a link to view the full article or webpage. For example, a user may stop scrolling at a news article headline about the recent presidential debate, continue scrolling, and then change scroll directions to come back to the article about the recent presidential debate.

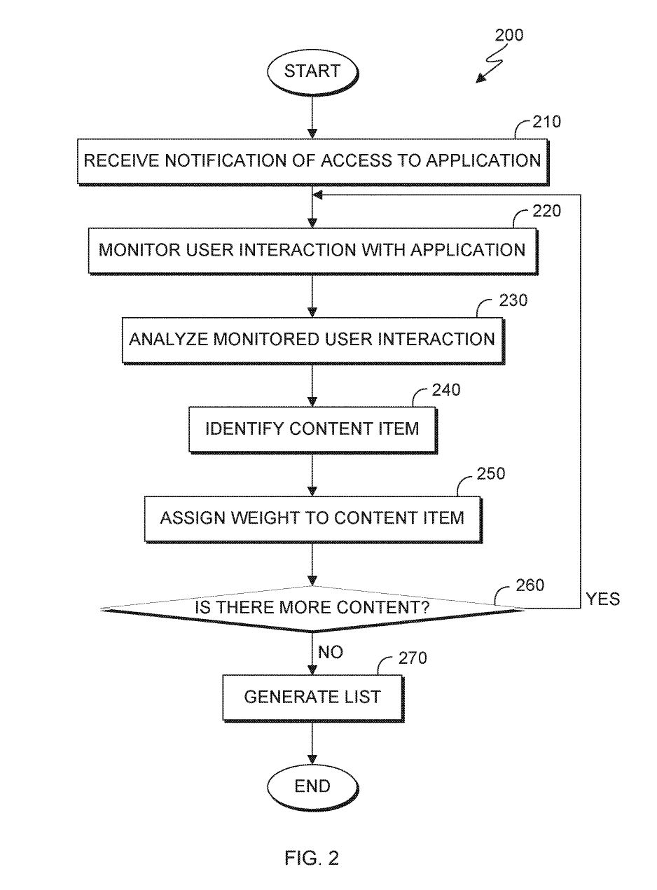

FIG. 2 depicts a flowchart 200 of the steps of recall program 30 executing within the computing environment of FIG. 1, in accordance with an embodiment of the present invention. In the depicted embodiment, recall program 30 operates to monitor and analyze a user's interaction with content items in an infinite scroll, assign a weight to each content item, and create a list of the weighted content items. Recall program 30 differentiates users of an application based on login information or computing device information.

In step 210, recall program 30 receives a notification of access to an application. In this embodiment, recall program 30 receives a notification that a user has accessed application 40. For example, recall program 30 can receive a notification when a user of computing device 60 opens or loads application 40. In instances where a user of computing device 60 opens or loads user interface 70, content items can be transmitted to and subsequently displayed to user interface 70. In this embodiment, the initial content is displayed in an infinite scroll. As the user scrolls down the infinite scroll, additional content items can be transmitted to and subsequently displayed to user interface 70. For example, a user of a laptop computer opens a sports website, which displays the initial set of sports articles in an infinite scroll for the user to scroll through and interact with. As the user scrolls down the webpage, more sports articles are automatically loaded in the infinite scroll.

In step 220, recall program 30 monitors a user's interaction with an application, such as application 40. Types of user interaction that recall program 30 can monitor include the duration of time the user spends in the application, the geographic location where the user runs the application, and the types of content consumed by the user. For example, when a user opens a social media application with a newsfeed, recall program 30 may identify that the user scrolled through the newsfeed content items for 35 minutes before closing the application. In an embodiment, recall program 30 will access the geographic location of where the user is running user interface 70 of application 40 based on the GPS coordinates of computing device 60. For example, when a user opens a news webpage, recall program 30 may identify that the user was located in Atlanta while scrolling through news article headlines. In another example, when a user opens a sports mobile application, recall program 30 may identify that a user interacts generally with posts about college basketball. In some embodiments, additional indications of user interaction that recall program 30 can monitor include pausing on the content item, clicking a link associated with the content item, commenting, sharing, liking, pinning, viewing the embedded video, etc. For example, recall program 30 will monitor if a user, while in a social media application, pauses on a video clip from a basketball game and doesn't resume scrolling until the video clip has ended. In other embodiments, indirect indications of user interaction that recall program 30 may monitor include scrolling speed, pause points, change in scroll direction, returning to a previous location, touching of the screen by user, resizing of content, expansion of comment section, clicking on associated links, etc.

In step 230, recall program 30 analyzes the monitored user interaction. In an embodiment, recall program 30 may store historical user consumption data related to the monitored user interaction to a repository (not shown) on server 20. In an embodiment, recall program 30 analyzes the historical user consumption data to determine the user's typical duration of time or time window when he or she is interacting with content items in application 40. The typical time window may be for a particular time of day, a particular day, a particular weekday, or a particular weekend day. For example, if a user accesses a first application on a Monday from 8:02-8:55 am, on a Tuesday from 8:00-9:01 am, on a Wednesday from 7:57-8:59 am, on a Thursday from 8:04-9:00 am, on a Friday from 8:07-9:02 am, and on a Saturday from 1:05-1:46 am, recall program 30 can determine that the user typically spends about an hour on weekday mornings interacting with the first application.

In an embodiment, recall program 30 analyzes the historical user consumption data to determine the user's typical geographic locations where they are interacting with content items in application 40. The typical geographic location may be for a particular time of day, a particular day, a particular weekday, or a particular weekend day. For example, if a user accesses a second application on Mondays at home, on Tuesdays at work, on Wednesdays at home, and on Thursdays at work, recall program 30 can determine that the user typically is at home on Mondays and Wednesdays when interacting with the second application and is typically at work on Tuesdays and Thursdays when interacting with the second application.

In an embodiment, recall program 30 analyzes the historical user consumption data to determine the typical type of content that the user is interacting with in application 40. For example, if a user accessing a sports application generally clicks links of content items related to college basketball, recall program 30 can determine that the user typically interacts with college basketball content items when on the sports application. In this embodiment, recall program 30 uses natural language annotations (e.g. sentence splitting, tokenization, POS tagging, chunking, dependency parsing, anaphora resolution, etc.) to process the semantics of the content items to determine the type of content. In this embodiment, types of content can include, but are not limited to, sports, geography, politics, news, entertainment, etc.

In step 240, recall program 30, identifies a content item. A content item may be a link to the full article, a status update, a picture, a tweet, an embedded video, etc. In an embodiment, recall program 30 may identify every content item that a user scrolls by in an infinite scroll. In another embodiment, recall program 30 may identify only the content items that a user interacts with as described in step 220.

In step 250, recall program 30 assigns a weight to the content item. In this embodiment, a weight is a measure of the user's interest in the content item. In this embodiment, a weight is assigned for each respective user interaction (e.g. duration of time, geographic location, pausing, etc.) with a content item. In this embodiment, a content item assigned a higher weight indicates that it would be of higher user interest than a content item having a lower weight. In this embodiment, a numerical weighting scale is used, where lower numbers represent lower weights and higher numbers represent greater weights. In other embodiments, any desirable weighting scale can be used.

In this embodiment, recall program 30 assigns a weight based, at least in part, on the duration of time spent interacting with the content item relative to the typical time window determined in step 230. For example, if a user's typical time window for using a social media application is 60 minutes and the user interacts with a content item for 6 minutes, then recall program 30 can assign a weight of 1/10 for the content item. Recall program 30 further assigns a weight based in part on the geographic location where the content item is interacted with relative to the typical geographic location determined in step 230. For example, if a user typically uses a social media application at home and work, then when the user interacts with content items on the social media application while at a store, recall program 30 can consider these interactions as outliers or exceptions to the typical occurrences when assigning a weight. Recall program 30 further assigns a weight based in part on the type of content item relative to the typical type of content item determined in step 230. For example, if a user typically interacts with content items on a sports website related to college basketball, then recall program 30 can assign a higher weight to college basketball content items interacted with than non-college basketball content items. In other embodiments, recall program 30 may consider other factors when assigning a weight to the content item. The other factors may include but are not limited to scrolling speed, pause points, change in scroll direction, returning to a previous location, touching of the screen by the user, resizing of the content item, expansion of a comment section, and clicking on associated links.

In decision 260, recall program 30 determines whether there is another content item. In this embodiment, recall program 30 determines whether there is another content item by determining that a user has stopped scrolling or has exited out of the application. If in decision 260, recall program 30 determines there is another content item, then, recall program 30 will go back to step 220. If in decision 260, recall program 30 determines there are no more content items, then, recall program 30 will move on to step 270. For example, a user has closed out of an application.

In step 270, recall program 30 generates a list of previously consumed content items. In this embodiment, recall program 30 generates a list of previously consumed content items by ordering the weighted content items from highest to lowest weight. In some embodiments, recall program 30 generates a list of previously consumed content items of a specific content type. For example, where a user searches for “basketball,” recall program 30 will generate a search result of previously viewed content items specific to “basketball.” In an embodiment, server 20 may use the list of previously viewed content items in determining the user's preferences for certain content items. In another embodiment, recall program 30 may use or display the list of previously viewed content items in another section of application 40. For example, if application 40 is a website with an infinite scroll of content items down the center of the webpage, then, along the left hand side of the webpage, there could be a “previously viewed” section, which is generated using the list of previously viewed content items. In another embodiment, recall program 30 may use the list of previously viewed content items to help generate search results. For example, when a user searches for “basketball,” the server 20 could search through the list of previously viewed content items first for any related to “basketball.” In another embodiment, recall program 30 may use the list of previously viewed content items to highlight or make stylistic changes to certain content items. For example, if a content item is weighted above a certain threshold, the content item could be highlighted, bolded, or stylized differently from other content items in the infinite scroll. In another embodiment, recall program 30 may use the list of previously viewed content items to reorder the content items in the infinite scroll or move certain previously viewed content items to the top of the infinite scroll. For example, if a user has been scrolling through an infinite scroll and then returns to the top of the scroll, recall program 30 could update the infinite scroll by putting the content items above a certain threshold weight at the top of the scroll. Accordingly, in this embodiment, recall program 30 assigns and generates a list of previously viewed content items that a user may be interested in further interacting with. In this manner, embodiments of the present invention can help a user find content items of interest in instances where an infinite scroll is used.

FIG. 3 depicts a block diagram of components of server computer 300 in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Server computer 300 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Recall program 30 and application 40 are stored in persistent storage 308 for access and/or execution by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including resources of computing device 60 via a network (e.g., 50). In these examples, communications unit 310 includes one or more network interface cards. Communications unit 310 may provide communications through the use of either or both physical and wireless communications links. Recall program 30 and application 40 may be downloaded to persistent storage 308 through communications unit 310.

I/O interface(s) 312 allows for input and output of data with other devices that may be connected to server computer 300. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention, e.g., recall program 30 and application 40, can be stored on such portable computer-readable storage media and can be loaded onto persistent storage 308 via I/O interface(s) 312. I/O interface(s) 312 also connect to a display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for optimizing content recall in an infinite scroll, the method comprising:
receiving a request to access an application, wherein the application includes an infinite scroll feature with a content item;
monitoring, by one or more processors, user interaction with the content item within the application;
comparing, by one or more processors, the user interaction with the content item to historical user consumption data, wherein the historical user consumption data includes average duration of time per user interaction session, geographic location, and type of application;
assigning, by one or more processors, a weight factor to the content item based, in part, on the comparison of the user interaction with the application to the historical user consumption data; and
adding, by one or more processors, the content item to a list of previously consumed content items.

2. The method of claim 1, wherein adding the content item to the list of previously consumed content items comprises:
creating, by one or more processors, the list of previously consumed content items, wherein the list of previously consumed content items is ordered based, at least in part, on the weight factor assigned to the content item.

3. The method of claim 1, further comprising: presenting, by one or more processors, the list of previously consumed content items.

4. The method of claim 1, further comprising:
receiving a search query;
searching, by one or more processors, the list of previously consumed content items for the search query; and
returning, by one or more processors, results of the search.

5. The method of claim 1, further comprising:
reordering, by one or more processors, the infinite scroll feature based, at least in part, on the list of previously consumed content items.

6. The method of claim 1, wherein monitoring user interaction with the content item within the application comprises monitoring indirect indications of consumption of the content item.

7. The method of claim 5, wherein the indirect indications of consumption comprise, at least one of, scroll speed, pause points, change in scroll direction, return to a previous location within the application, resizing of content, and expansion of a comment section of the content item.

8. The method of claim 1, wherein comparing the user interaction with the application to historical user consumption data comprises comparing, by one or more processors, a duration of time interacting with the content item to the average duration of time per user interaction session.

9. The method of claim 1, further comprising:
updating, by one or more processors, the historical user consumption data with the monitored user interaction with the content item within the application.

10. A computer program product for optimizing content recall in an infinite scroll, the computer program product comprising:
one or more computer readable storage media and program instructions stored on the one or more computer-readable storage media, the program instructions comprising:
program instructions to receive a request to access an application, wherein the application includes an infinite scroll feature with a content item;
program instructions to monitor user interaction with the content item within the application;
program instructions to compare the user interaction with the content item to historical user consumption data, wherein the historical user consumption data includes average duration of time per user interaction session, geographic location, and type of application;
program instructions to assign a weight factor to the content item based, in part, on the comparison of the user interaction with the application to the historical user consumption data; and
program instructions to add the content item to a list of previously consumed content items.

11. The computer program product of claim 10, wherein the program instructions to add the content item to the list of previously consumed content items comprise:
program instructions to create the list of previously consumed content items, wherein the list of previously consumed content items is ordered based, at least in part, on the weight factor assigned to the content item.

12. The computer program product of claim 10, further comprising:
program instructions, stored on the one or more computer readable storage media, to present the list of previously consumed content items.

13. The computer program product of claim 10, further comprising:
program instructions, stored on the one or more computer readable storage media, to receive a search query;
program instructions, stored on the one or more computer readable storage media, to search the list of previously consumed content items for the search query; and
program instructions, stored on the one or more computer readable storage media, to return results of the search.

14. The computer program product of claim 10, further comprising:
program instructions, stored on the one or more computer readable storage media, to reorder the infinite scroll feature based, at least in part, on the list of previously consumed content items.

15. The computer program product of claim 10, wherein the program instructions to compare the user interaction with the application to historical user consumption data comprise program instructions to compare a duration of time interacting with the content item to the average duration of time per user interaction session.

16. A computer system for optimizing content recall in an infinite scroll, the computer system comprising:
one or more computer processors;
one or more computer readable storage media;
program instructions stored on the computer readable storage media for execution by at least one of the one or more processors, the program instructions comprising:
program instructions to receive a request to access an application, wherein the application includes an infinite scroll feature with a content item;
program instructions to monitor user interaction with the content item within the application;
program instructions to compare the user interaction with the content item to historical user consumption data, wherein the historical user consumption data includes average duration of time per user interaction session, geographic location, and type of application;
program instructions to assign a weight factor to the content item based, in part, on the comparison of the user interaction with the application to the historical user consumption data; and
program instructions to add the content item to a list of previously consumed content items.

17. The computer system of claim 16, wherein the program instructions to add the content item to the list of previously consumed content items comprise:
program instructions to create the list of previously consumed content items, wherein the list of previously consumed content items is ordered based, at least in part, on the weight factor assigned to the content item.

18. The computer system of claim 16, further comprising:
program instructions, stored on the one or more computer readable storage media for execution by at least one of the one or more processors, to present the list of previously consumed content items, wherein the list of previously consumed content items is ordered based, at least in part, on the weight factor assigned to the content item.

19. The computer system of claim 16, further comprising:
program instructions, stored on the one or more computer readable storage media for execution by at least one of the one or more processors, to receive a search query;
program instructions, stored on the one or more computer readable storage media for execution by at least one of the one or more processors, to search the list of previously consumed content items for the search query; and
program instructions, stored on the one or more computer readable storage media for execution by at least one of the one or more processors, to return results of the search.

20. The computer system of claim 16, wherein the program instructions to compare the user interaction with the application to historical user consumption data comprise program instructions to compare a duration of time interacting with the content item to the average duration of time per user interaction session.
